(19) United States
(12) Patent Application Publication
(10) Pub. No.: US 2005/0240386 A1
(43) Pub. Date: Oct. 27, 2005

(54) Method and system for interactive modeling of high-level network performance with low-level link design

(75) Inventors: Juan-Antonio Carballo, Austin, TX (US); Kevin John Nowka, Round Rock, TX (US)

Correspondence Address: Andrew M. Harris;Weiss, Moy & Harris, P.C., 4204 North Brown Ave., Scottsdale, AZ, 85251-3914, US

(73) Assignee: International Business Machines Corporation, Armonk, NY (US)

(21) Appl. No.: 10/829,829

(22) Filed: Apr. 22, 2004

(51) Int. Cl. G06F 17/50

(52) U.S. Cl. 703/14

(57) ABSTRACT

A method and system for interactive modeling of high-level network performance with low-level link design provides a tool for optimizing networked computing systems and their link components simultaneously. The method models a fixed portion of a network and specifies operational performance levels and power constraints. A solution is chosen for a non-fixed network portion and the network is simulated to determine link requirements and synthesizes links in conformity with the link requirements. The links are analyzed to determine performance (e.g., bandwidth) and requirements (e.g., power) and network performance is recalculated. An iterative loop from the selection of the non-fixed topology through synthesis and recalculation of link performance can be implemented to optimize the link and network design. The links may be links that use an adaptive management policy that trades off power and bandwidth in multiple operating modes and the method may be used to optimize the operating modes and/or management rules.

This invention was made with Government support under NBCH30390004 awarded by the Defense Advanced Research Project Agency. The Government has certain rights in this invention.

### BACKGROUND OF THE INVENTION

1. Field of the Invention

The present invention is related to network system and circuit modeling methods and software, and more particularly to a modeling method and software that provides interaction between a high-level network model and a low-level link model.

2. Description of Related Art

Network system and circuit modeling methods, typically implemented in software tools, simulate the performance of network systems and circuits for design optimization, synthesis and performance verification. Network synthesis tools provide a mechanism for optimizing and ensuring proper performance of network systems. Link design tools are typically circuit modeling tools used by a link designer to meet specifications derived by a network designer.

Link design parameters, particularly in recently developed link circuits that have policy-based adjustable performance, are particularly difficult to determine with respect to the network performance that dictates their operational requirements. In particular, the specific selectable performance levels (and thus the operating power and complexity required to those performance levels) are somewhat arbitrarily generated in that it is difficult to estimate the effect of those levels on network performance.

The procedure for designing networks and links are typically separate, with any interaction being handled by human intervention via negotiation of specifications. For example, a network designer might specify the required bandwidth or bandwidth levels of a link based on a software analysis and the link designer attempts to meet the specification based on constraints such as power consumption and circuit complexity/area. If the specifications cannot be met within power or complexity requirement, then the network may be redesigned to enable a link design that meets the requirements. While the typical design process provides network functionality if the other constraints can be met, an optimal design is not typically produced. Further optimization can be performed iteratively via interaction between the network and link designers, but the number of iterations possible is inherently limited by the process and resources may be wasted on producing actual hardware that does not provide an optimal result.

Further, in general, most of the existing network design software and thus typically performed network design procedure is centered around the processing units and high-level network design and not the interconnect (link) layer design. Therefore, little focus has been placed on link design with respect to network design. However, link power consumption is a significant portion of overall network power consumption, particularly in distributed computing systems with wide high-speed interconnects.

Therefore, it would be desirable to provide modeling methods and modeling software that accurately predict the performance of a network based on design parameters of links within the network and permit design of the link and/or determination of link performance levels. It would further be desirable to provide an iterative computer-based solution that does not require human intervention that relates network performance and design with link performance and design so that link and network design may be optimized together. In particular, it would be desirable to provide such a solution that can determine particular optimized link design levels for link policy management that provide optimized balancing of network performance and power consumption.

### SUMMARY OF THE INVENTION

The above objectives of providing network and link design in an iterative computer-based solution that further aids in determination of link performance/power levels for policy-managed adaptive links, is provided in a method and system for simultaneously and interactively modeling high-level network and low-level link performance.

The method may be embodied in a computer system executing program instructions for carrying out the steps of the method and may further be embodied in a computer program product containing program instructions in computer-readable form for carrying out the steps of the method.

The method models a network design as a fixed portion and a variable portion. A solution for the non-fixed network portion is chosen and link requirements are determined for the network interconnects. Links are synthesized in conformity with the link requirements. The synthesized links are analyzed to determine performance factors such as link bandwidth and requirements such as link power consumption. Network performance is then recalculated based on the link performance. The non-fixed network solution selection and link synthesis/analysis may be iterated to optimize the link design.

If the links have multiple operating modes trading off power and bandwidth, the method may be used to optimize the levels (e.g., the power vs. bandwidth levels selectable in the design). Also, if management policy rules are used to select the operating modes of the links, the rules may also be optimized by the method by observing the performance and energy consumption of the network over load conditions that exercise the management policy (i.e., cause the links to cycle sufficiently through the various operating modes).

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a pictorial diagram of a workstation computer system in which methods in accordance with an embodiment of the present invention are performed.

FIG. 2A is a block diagram of a network as modeled by software in accordance with an embodiment of the present invention.

FIG. 2B is a block diagram showing details of a link as modeled by software in accordance with an embodiment of the present invention.

FIG. 3 is a block diagram showing an organization of software in accordance with an embodiment of the present invention.

FIGS. 4A and 4B are block diagrams showing details of the organization of the logical link model 46 of FIG. 3.

FIG. 5 is a flow chart of a method in accordance with an embodiment of the present invention.

### DETAILED DESCRIPTION OF PREFERRED EMBODIMENT

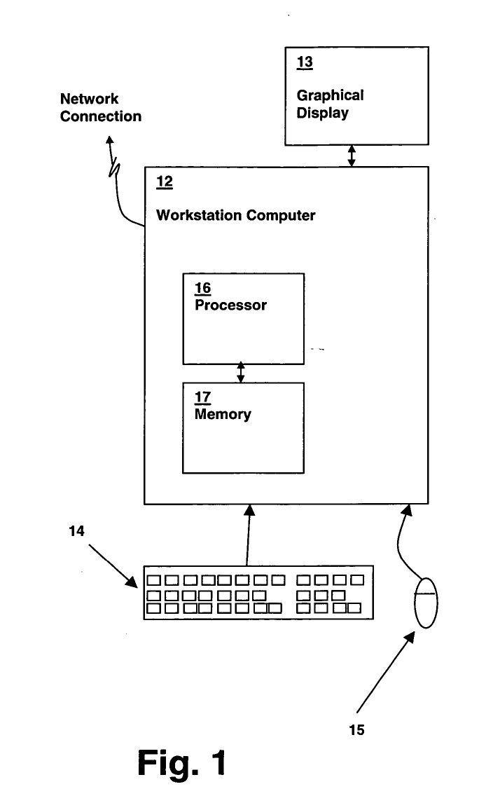

Referring to the figures, and particularly to FIG. 1, a workstation computer system, in which methods according to an embodiment of the present invention are performed, is depicted. A workstation computer 12, having a processor 16 coupled to a memory 17, for executing program instructions from memory 17, is shown. The program instructions include program instructions for executing one or more methods in accordance with an embodiment of the present invention. The methods of the present invention are directed toward interactively modeling a network along with lower level models of links between network processing units and links between switching components of the network. By providing interaction between the network model and the model of the links, both the network and the link design may be optimized by iteration. In particular, networks with adaptive links that use a management policy to determine the appropriate operating mode for the link may be optimized as to management policy rules and link operating mode bandwidth and other characteristics versus link power requirements. Because link power is a significant portion of overall network power requirements, the resulting optimized network can show significantly lower overall power consumption/dissipation. The high-level network performance and constraints that are optimized may be power consumption alone or may include or consist of other criteria. Examples of other high level network performance criteria that may be optimized in alternative to, or in conjunction with network power consumption are: network area/volume, cost and energy per packet.

Workstation computer 12 is coupled to a graphical display 13 for displaying program output such as simulation results and network/link model input, as well as control screens for setting parameters such as link management policy rules. Workstation computer 12 is further coupled to input devices such as a mouse 15 and a keyboard 14 for receiving user input. Workstation computer may be coupled to a public network such as the Internet, or may be coupled to a private network such as the various “intra-nets”, or may not be connected to any network at all, and software containing program instructions embodying methods in accordance with embodiments of the present invention may be located on remote computers or locally within workstation computer 12.

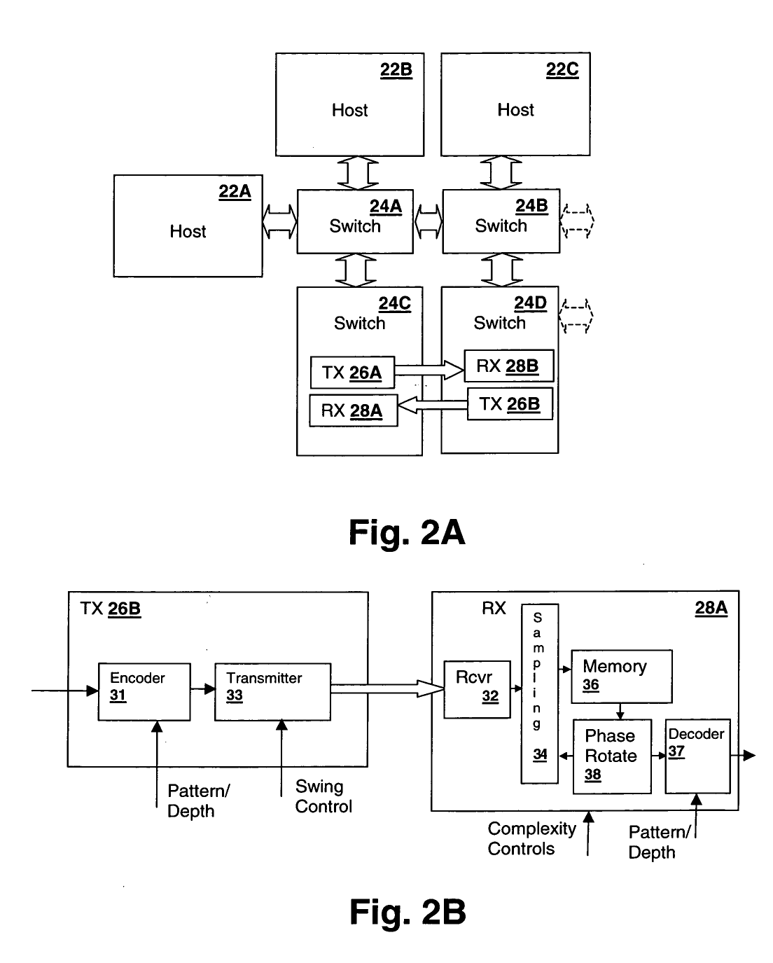

Referring now to FIG. 2A, a network as modeled by an embodiment of the present invention is depicted. Hosts 22A-22C comprise processing units for receiving and transmitting packets within the network. Switches 24A-24D interconnect hosts 22A-22C was well as connecting hosts 22A-22C to other switches and hosts. Switches 24A-24D included high-speed data communication links formed from transmitter (26A, 26B) receiver (28A, 28B) pairs, at least some of which include multiple operating modes that trade off internal circuit complexity, frequency and voltage against power and performance/bandwidth requirements. By changing the operating mode of the links when the maximum throughput of the links is not required (e.g., during a period of low activity through the link), the power consumption of the network may be reduced. Likewise, when the traffic through a link is heavy, the traffic is supported by changing the operating mode of the link to temporarily support the higher required bandwidth, while consuming more power during that time period. Rule-based decision making provides a link management policy that adapts the link operating mode to the requirements for the link. Input to the rules may be observation of traffic at the link, or may be an observation at a higher level based on network heuristics. The operating modes may include changes in either transmitter (26A, 26B) operation and complexity such as transmitter power and/or coding type and/or receiver (28A, 28B) operation and complexity such as receiver amplifier power, phase rotator resolution, filter size, equalization length, detection processing (e.g., memory size and processing length for averaging and estimation) and coding type. Coding type affects both transmitter and receiver power, but is considered a “logical layer” as opposed to “physical layer” characteristic of a link. Physical layer characteristics include the above-mention memory size as well as processing overhead used in detection of a raw bit-stream. Circuit power for transmitters and receiver-side detectors are also physical link characteristics, as well as circuit size to provide phase rotation and storage for averaging and interpolation. Each of the above-recited factors, as well as others, determine the power consumed by link components. In a network with a large number of wide (e.g., 64-bit parallel) links, the operating power requirements of the links is substantial. Therefore, the link design and adaptive policy rules determine in part both the cost to operate the network and the heat generated by the network. Heat generated by the network affects reliability, density and cost to cool network components and facilities. The power consumption of links also dictates how many links may be integrated on a single die or within a package or subsystem, thereby limiting the integration level and thus raising the cost of a network.

Details of a link including transmitter 26B and receiver 28A are shown in FIG. 2B. Transmitter 26B includes transmitter circuit 33 and an encoder 31, that generally provides an error-correction coding (ECC) pattern to the bitstream transmitted by transmitter 26B to receiver 28A, but other types of coding may be employed (non correctable codes). Generally, the voltage swing of transmitter circuit 33 and the depth of coding provided by encoder 31 may be reduced via controls provided from an external control circuit. Receiver includes receiver circuits 32, sampling latches 34, memory 36, a phase rotator 38 and a decoder 37 for reconstructing the bit-stream encoded and transmitted by transmitter 26B. The complexity of the various blocks, as well as voltage levels within the receiver circuit can be adjusted by external controls in conformity with the adaptive link management policy. For example, the active phase rotator 38 resolution may be adjusted as well as the active size of memory 36 in order to increase reception signal processing or decrease receiver 28A power requirements. In general, the higher the throughput required from the link, the greater the processing requirements are within receiver 28A and transmitter 26B and therefore the greater the circuit power. However, the method of the present invention also provides optimization with respect to the link channel for a given link and therefore for relatively low bandwidths, some links may require greater processing (and thus power) expenditure and the modeling software will take that into account. For example, the network model of the present invention may include a model of which links are intra-cabinet vs. inter-cabinet, or may include the physical length of links, so that an estimate of channel quality forms a portion of the input for the network and link synthesis and analysis. In essence, this may be viewed as enforcing a different adaptive link management policy or different operating mode levels for the links, so that links that traverse cabinets will have a different design or management policy from links within cabinets when the network is optimized.

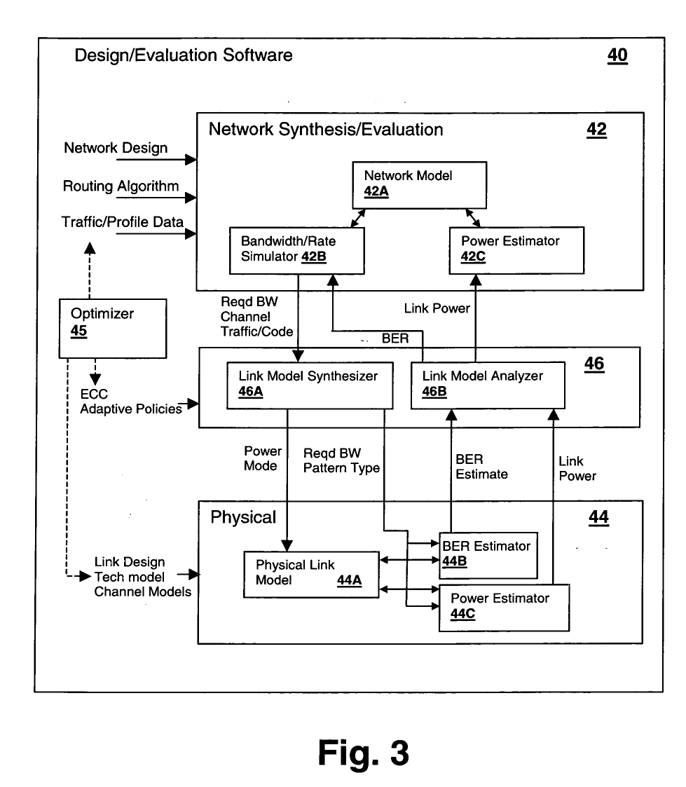

Referring now to FIG. 3, a block diagram depicting an organization of design/evaluation software 40 in accordance with an embodiment of the present invention is depicted. The design and evaluation blocks are divided into three levels, with an optimizer 45 block providing adjustment of values for iterating through options for the network and link design, as well as variations in network loading so that the designs are optimized across a range of potential network operating conditions. The top level of the design and evaluation is the network synthesis and evaluation block 42, that optionally receives as input a fixed set of network parameters (network design), one or more network routing algorithms and topologies, and network traffic and profile data. Given this input, a typical network synthesis and evaluation may be performed, and in fact, network synthesis and evaluation block 42 may be provided by connecting network synthesis and evaluation tools to a parameter-based network model. However, the organization of the connection of network synthesis and evaluation block 42 is new in that network synthesis and evaluation block 42 is connected to other software blocks that provide control of the inputs based on further processing of the outputs of network synthesis and evaluation block 42, so that an iterative process can be further provided to optimize the network design from lower-level link models provided in the embodiments of the invention. The outputs of network synthesis and evaluation block 42 provide inputs to specify link requirement, including required bandwidth, channel traffic and coding requirements for the links that are determined by bandwidth/rate simulator 42B that simulates the virtual links within a network model 42A. Further input is provided network synthesis and evaluation block 42 from the link models. Link power information is supplied to a network power estimator 42C, while bandwidth/rate simulator 42B receives BER information. The power and BER information are generated for each actual synthesis evaluation cycle so that network model 42A can be adjusted on a next iteration.

The next level down in the design/evaluation hierarchy is a logical link modeling block 46 that receives the link requirements from network synthesis and evaluation block 42 and synthesizes links in accordance with the requirements in a link model synthesizer block 46A. The link model synthesizer provides power mode information for the physical links, which may be based on adaptive link policy management rules input to logical link modeling block 46. Link model synthesizer 46A also determines required physical link bandwidth and pattern/coding type for the links (Link coding type may be set manually by the designer, or may be set from requirements determined by the higher-level network simulation results). Logical link modeling block 46 also includes a link model analyzer 46B that determines actual link power consumption from input received from a physical link model as well as information about coding processing and overhead at the logical link level, along with BER information for the logical links. The above-listed information is supplied to network synthesis and evaluation block 42 so that network power and performance are accurately reflected in the network evaluation and so that feedback is provided to network synthesis and evaluation block 42 that reflects the synthesis of links that is performed in accordance with the outputs from network synthesis and evaluation block 42 at each iteration.

The lowest level of the modeling software is a physical link modeling block 44 that includes a physical link model 44A as well as a BER performance estimator 44B and a physical link power estimator 44C. Physical link modeling block 44 receives the link operating specifiers (power mode, required bandwidth, coding type) provided from logical link modeling block 46 and further input provided by the optimizer or other fixed input includes link designs, the technology model and models of the physical channels over which the links must operate. The results of the physical link evaluation (physical BER and physical link power) are returned to the logical link modeling block 46.

The overall connection of network/logical link/physical link synthesis and evaluation tools depicted in FIG. 3 provides for optimizing the design at each of the three levels by providing design vectors for the values that can be adjusted. For example, the following table depicts a possible vectorization of design parameters across the three levels:

TABLE I

| Level | Vector Member | | | | | |
|---|---|---|---|---|---|---|
| Net- | Topology | Switch | Routing | Protocol | | |
| work | | Width | Algorithm | | | |
| Layer | | | | | | |
| Logical | Coding | ECC | Channel- | | | |
| | | | related | | | |
| | | | coding | | | |
| Physical | Loop BW | Filter | Loop | Phase | Driver | EQ |
| Link | | size | Order | Resolution | Strength | sample |
| | | | | | | depth |

Each of the vector members shown in Table I above can be used to adjust/track the design of the network at all three levels using a single design vector that can be used to track attempts that fail or succeed in meeting required levels of network performance and can further be stored in association with, for example, a network power requirements level in order to track optimization of the network with respect to power consumption/dissipation. By iterating through changes in the vector, the network may be optimized and operation verified prior to physical implementation of the network and links. The vector members shown above for the physical link level may be adjustable via an adaptive policy and a set of adaptive policies may be specified as a vector member in the alternative, so that a policy may be optimized. Or, as specified in Table I the operating mode values may be the vector members for a fixed policy and may themselves be optimized for that policy.

The exemplary vector members for the network level are:

1) Topology—in general the “non-fixed” portion of a network topology. Generally, some of the network topology will be fixed, either by design choice, or to limit possible iteration.
2) Switch Width—the width of the links
3) Routing algorithm—the algorithm that operates the switches to route packets.
4) Protocol—the high-level packet protocol used through the switches (e.g., TCP)
   The exemplary vector members for the logical link level are:
1) Coding depth—the depth of the coding applied (e.g., ECC polynomial order)
2) Error Correction/Non-Error Correction (type of code)
3) Channel-related coding (e.g., 8 B/10 B coding, scrambling, etc.)
   The exemplary values for the physical link level are:
1) Loop bandwidth—bandwidth of control loop used to detect signal/correct phase
2) Filter type—type of filtering used in receiver
3) Loop Order—the control algorithm complexity for phase correction/signal detection
4) Phase resolution—number of steps in phase rotator
5) Driver Strength—signal swing from TX driver
6) Equalization Sample Length—the complexity of any EQ filter used.

Optimizer 45 generates vectors using the above members and tracks the success or failure of the network and link evaluations (and also whether or not synthesis failed or succeeded at each level) so that possible solutions are stored while more optimal solutions are explored.

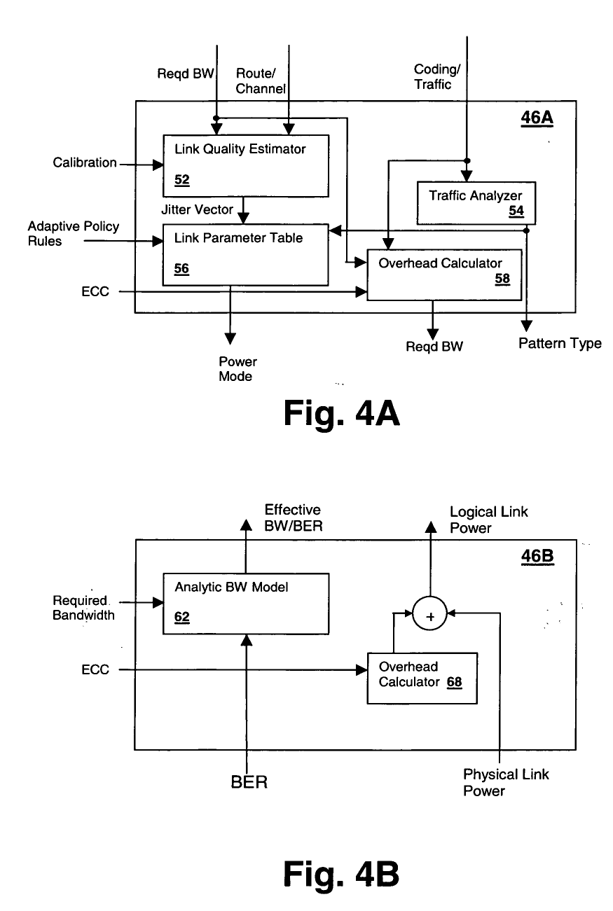

Referring now to FIG. 4A, details of link model synthesizer 46A are depicted. Link model synthesizer 46A includes a link quality estimator 52 module that receives the required bandwidth, routing and channel information for each link and then provides an estimate of link “difficulty” or required link performance, as an estimate of jitter (jitter vector). Calibration values may be inserted ensure good estimation when tuning the link model for best performance as part of the optimization algorithm. Link model synthesizer receives inputs from bandwidth rate simulator 42B as well as from a traffic analyzer 54 that analyzes the traffic information provided from bandwidth rate simulator 42B and determines a pattern type for the physical link. The jitter vector is used in conjunction with the pattern type and adaptive policy rules to determine a selection from a link parameter table 56 that provides for selection of a type of link and a power mode for the link. An example of a link parameter table is supplied in Table II below:

TABLE II

| Inputs | | | Jitter Vector | | Power Mode | | | |
|---|---|---|---|---|---|---|---|---|
| BW | | Chan | Jittₐᵥ | Jittₚₖ | Loop BW | Filter | Order | EQ |
| 5 | Gbps | 30-in | 50 | 200 | ¼ rate | 8state | 1 | None |
| | | Metal | | | | FSM | | |
| | | type 2 | | | | | | |
| 10 | Gbps | 30-in | 100 | 300 | ½ rate | 16state | 1 | Pre- |
| | | Metal | | | | FSM | | emph |
| | | type 2 | | | | | | 1-b |
| 5 | Gbps | 30-in | 75 | 200 | ¼ rate | 16state | 1 | None |
| | | Metal | | | | FSM | | |
| | | type 4 | | | | | | |
| 10 | Gbps | 30-in | 200 | 300 | full | 32state | 1 | Pre- |
| | | Metal | | | rate | FSM | | emph |
| | | type 4 | | | | | | 3-b |
| 5 | Gbps | 10m | 100 | 200 | ¼ rate | 16state | 2 | Pre- |
| | | Cable | | | | FSM | | emph + |
| | | | | | | | | DFE |
| 10 | Gbps | 10m | 250 | 300 | full | 64state | 2 | Pre- |
| | | Cable | | | rate | FSM | | emph + |
| | | | | | | | | DFE |

According to Table II, the program inputs for link parameter table 56 selection are the required bandwidth of the link (BW), the channel type (e.g., circuit metal vs. cable, length, and type) along with high and low frequency jitter factors from the jitter vector. The power mode can then be determined by selecting the table entry that meets the bandwidth and jitter vector requirements for the given channel type. The power mode factors include the loop bandwidth, filter type (number of states in finite state machine—FSM), the order of the control loop and the pre-emphasis and digital filtering applied (EQ). Link parameter table then provides power mode information to physical link model 44. The adaptive policy in the physical link model is explicitly embedded in link parameter table 56 by fixing the combinations for each power mode at a given performance level. However, as an alternative, a link simulation model may provide the output parameters for BER and bandwidth, rather than selecting a particular solution from table 56.

The final block in link model synthesizer 42A is an overhead calculator 58, that determines actual physical link required bandwidth from the link required bandwidth, the traffic estimate and the ECC coding applied at the logical link level. The bandwidth required of the physical link is then provided to physical link model 44.

Referring now to FIG. 4B, details of link model analyzer 46B are shown. From the BER reported by physical link model 44, and input required logical link bandwidth, an analytic bandwidth model 52 determines the effective bandwidth and BER for the link, which is returned to network synthesis and evaluation block 42. Logical link power is determined from a sum of the physical link power returned by physical link model 44 and the output of an overhead calculator 68 that determines the logical link overhead power requirements from the coding type and depth.

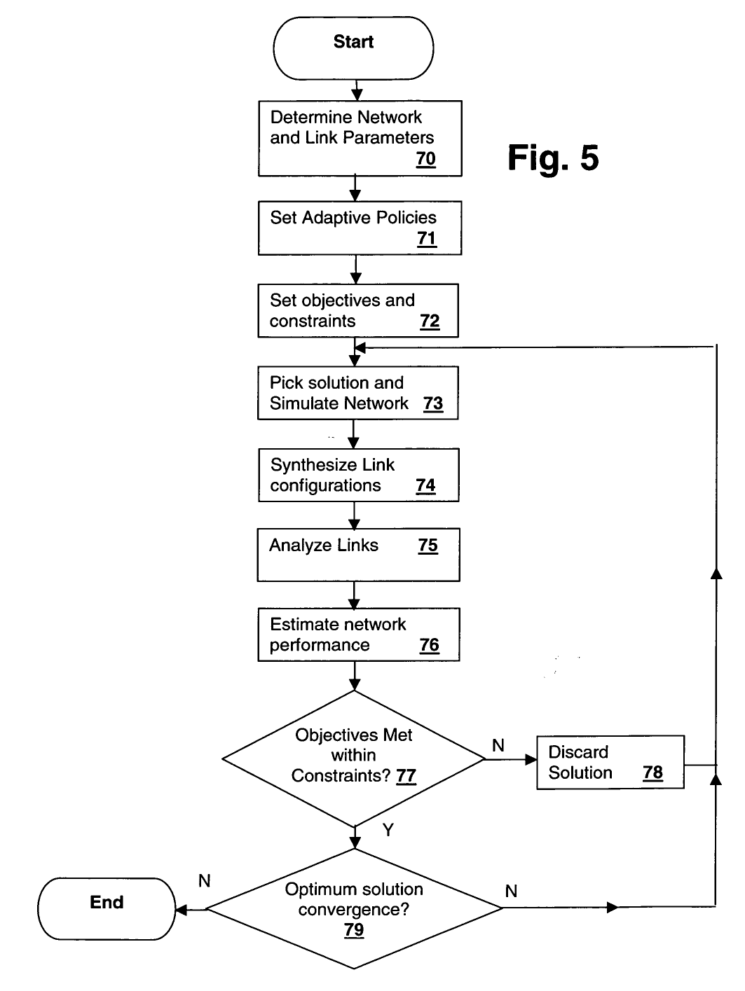

Referring now to FIG. 5, a method in accordance with an embodiment of the invention is illustrated in a flowchart. First, fixed network and link parameters are determined (step 70) and any adaptive link policies are set (step 71). Objectives and constraints are set for the network (step 72), e.g., the limits on network load simulations, performance/bandwidth ranges and power consumption ranges. A solution for the non-fixed network topology and the links is selected and the network is simulated to determine link requirements (step 73). Then, the link configurations are synthesized at the logical level (step 74). Next, the links are analyzed at the physical level to determine link performance and power requirements (step 75) and the network performance is then recalculated (step 76). If the objectives are not met within the constraints that were set in step 72, then the solution is discarded (step 78) and another iteration performed from solution selection step 73. If optimum solution convergence is detected (step 79) (or alternatively if the solution reaches and optimum threshold) the process is ended. If the solution does not meet the optimization criteria, the solution may be saved as a known good solution, but another iteration is commenced from step 72.

The above-described method is only one possible embodiment of the invention. For example, the adaptive policies may not be set in step 71, but may form part of the iterative optimization loop, where a solution includes selection of a particular policy from a set of policies, so that the policy itself may be optimized. Also, the above-described method may be used manually rather than in an iterative loop. As such, the method still provides significant advantages over the prior art, as the network model results are based on actual physical link modeling and parameters at multiple levels of abstraction can be optimized simultaneously.

While the invention has been particularly shown and described with reference to the preferred embodiments thereof, it will be understood by those skilled in the art that the foregoing and other changes in form, and details may be made therein without departing from the spirit and scope of the invention.

1. A method for modeling the behavior of a network and determining design parameters of a link within said, the method comprising:
setting a fixed portion of a topology of said network;
specifying operational performance levels and constraints for said network;
choosing a solution for a non-fixed portion of said network topology;
simulating said network consistent with said solution, to produce a link requirements result;
transporting said link requirements result as output data from a network simulation module to provide input data to a link synthesis module;
synthesizing links in accordance with said link requirements;
analyzing said synthesized links to determine performance and requirements of said synthesized links; and
calculating network performance and requirements in conformity with a result of said analyzing.

2. The method of claim 1, further comprising:
determining whether or not a result of said calculating meets a result of said specifying; and
in response to determining that said result of said calculating does not meet said result of said specifying, repeating said choosing, simulating, synthesizing, analyzing and calculating.

3. The method of claim 1, wherein said synthesizing comprises selecting a link type from a link parameters table.

4. The method of claim 1, wherein said links have multiple operating modes selectable in conformity with a link management policy, and wherein said method further comprises setting one or more policies of said links, whereby said one or more policies are optimized.

5. The method of claim 1, wherein said links have multiple operating modes selectable in conformity with a link management policy, and wherein said choosing chooses a particular operating mode for one or more of said links, whereby said simulating, synthesizing, analyzing and calculating are performed for said particular operating mode, whereby said performance and said requirements are optimized for said particular operating mode.

6. The method of claim 1, wherein said simulating specifies said link requirements result as a required bandwidth, a power mode and a pattern type.

7. The method of claim 1, wherein said performance is a bandwidth of said links and wherein said requirements are power requirements of said links.

8. A workstation computer system including a memory for storing program instructions and data, and a processor for executing said program instructions, and wherein said program instructions comprise program instructions for:
setting a fixed portion of a topology of said network;
specifying operational performance levels and constraints for said network;
choosing a solution for a non-fixed portion of said network topology;
simulating said network consistent with said solution, to produce a link requirements result;
synthesizing links in accordance with said link requirements;
analyzing said synthesized links to determine performance and requirements of said synthesized links; and
calculating network performance and requirements in conformity with a result of said analyzing.

9. The workstation computer system of claim 8, wherein said program instructions further comprise program instructions for:
determining whether or not a result of said calculating meets a result of said specifying; and
in response to determining that said result of said calculating does not meet said result of said specifying, repeating said choosing, simulating, synthesizing, analyzing and calculating.

10. The workstation computer system of claim 8, wherein said program instructions for synthesizing select a link type from a link parameters table.

11. The workstation computer system of claim 8, wherein said links have multiple operating modes selectable in conformity with a link management policy, and wherein said program instructions further comprise program instructions for setting one or more policies of said links.

12. The workstation computer system of claim 8, wherein said links have multiple operating modes selectable in conformity with a link management policy, and wherein said program instructions for choosing choose a fixed operating mode for one or more of said links, whereby said simulating, synthesizing, analyzing and calculating are performed for said fixed operating mode, whereby said performance and said requirements are optimized for said fixed operating mode.

13. The workstation computer system of claim 8, wherein said program instructions for simulating specify said link requirements result as a required bandwidth, a power mode and a pattern type.

14. The workstation computer system of claim 8, wherein said performance is a bandwidth of said links and wherein said requirements are power requirements of said links.

15. A computer program product comprising signal-bearing media encoding program instructions for execution on a general-purpose computer system, wherein said program instructions comprise program instructions for:
setting a fixed portion of a topology of said network;
specifying operational performance levels and constraints for said network;
choosing a solution for a non-fixed portion of said network topology;
simulating said network consistent with said solution, to produce a link requirements result;
synthesizing links in accordance with said link requirements;
analyzing said synthesized links to determine performance and requirements of said synthesized links; and
calculating network performance and requirements in conformity with a result of said analyzing.

16. The computer program product of claim 15, wherein said program instructions further comprise program instructions for:
determining whether or not a result of said calculating meets a result of said specifying; and
in response to determining that said result of said calculating does not meet said result of said specifying, repeating said choosing, simulating, synthesizing, analyzing and calculating.

17. The computer program product of claim 15, wherein said program instructions for synthesizing select a link type from a link parameters table.

18. The computer program product of claim 15, wherein said links have multiple operating modes selectable in conformity with a link management policy, and wherein said program instructions further comprise program instructions for setting one or more policies of said links.

19. The computer program product of claim 15, wherein said links have multiple operating modes selectable in conformity with a link management policy, and wherein said program instructions for choosing choose a fixed operating mode for one or more of said links, whereby said simulating, synthesizing, analyzing and calculating are performed for said fixed operating mode, whereby said performance and said requirements are optimized for said fixed operating mode.

20. The computer program product of claim 15, wherein said program instructions for simulating specify said link requirements result as a required bandwidth, a power mode and a pattern type.

21. The computer program product of claim 15, wherein said performance is a bandwidth of said links and wherein said requirements are power requirements of said links.
